(19) United States
(12) Patent Application Publication
(10) Pub. No.: US 2002/0178238 A1
(43) Pub. Date: Nov. 28, 2002

(54) Caching address information in a communications system

(76) Inventors: Thomas Fletcher, San Diego, CA (US); Douglas Dillon, Gaithersburg, MD (US); John Border, Boyds, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/863,157

(22) Filed: May 23, 2001

(51) Int. Cl. G06F 15/177; G06F 15/173

(52) U.S. Cl. 709/220; 709/226

(57) ABSTRACT

An approach for performing an address look-up in a relatively high latency network is disclosed. A terminal receives a query from a local host requesting address information. The terminal includes a memory that stores the address information, and a processor that is coupled to the memory and is configured to determine whether the address information associated with the query is stored in the memory. The processor selectively transmits the address information to the local host in response to the determination. The system also includes a server that communicates with the terminal over the network. The server receives the query from the terminal and transmit the address information corresponding to the query to the terminal. The present invention has particular applicability to a communications system that employs a satellite network.

### BACKGROUND OF THE INVENTION

1. Field of the Invention

The present invention relates generally to a broadband communications system, and is more particularly related to caching address information.

2. Discussion of the Background

The maturity of electronic commerce and acceptance of the Internet as a daily tool by a continually growing user base of millions of users intensify the need for communication engineers to develop techniques for enhancing network performance. With the advances in processing power of desktop computers, the average user has grown accustomed to sophisticated multimedia applications, which place tremendous strain on network resources (e.g., switch capacity). Also, because the decrease in application response times is a direct result of the increased processor performance, the user has grown less tolerant of network delays, demanding comparable improvements from the network infrastructure. Therefore, network performance enhancing mechanisms are needed to optimize efficiency and reduce user response times. These mechanisms are imperative in systems with relatively high network latency, such as a satellite network.

The robustness of the global Internet stems in part from the naming system that is in place for one machine to communicate with another machine. The naming system that has been adopted is known as the Domain Name System (DNS), which permits machines to be identified by “domain names” (i.e., host names), which provide a more readily usable address naming scheme for human recognition; for example, “hns.com”. Applications, such as e-mail or web-browsing, utilize domain names in their communication with remote machines and other processes. This communication requires the translation or mapping of domain names to numeric addresses, such as Internet Protocol (IP) addresses, to reach specific machines. In essence, DNS provides a mapping of domain names to IP addresses. The DNS is a distributed database that stores the domain name, IP address, as well as other information about hosts. The distributed database is implemented by storing various portions of the database across multiple servers in a hierarchical structure—these servers are termed “DNS servers.” Thus, the host associated with the application submits queries to a DNS server for a specific IP address of a particular destination machine.

The queries to and responses (i.e., answers) from the DNS server may require a number of message exchanges to the requesting host as well as other DNS servers. These message exchanges introduce delay in application response times. This delay is particularly prominent when the transmission traverses a network with relatively high latency, such as a satellite network.

Based on the foregoing, there is a clear need for improved approaches for providing address resolution over a relatively high latency network. There is also a need to reduce delay associated with the address resolution process. There is a further need to enhance application response time from the user perspective.

### SUMMARY OF THE INVENTION

The present invention addresses the above stated needs by providing a terminal with the capability to cache address information, such that a host that is local to the terminal may submit a query to retrieve the address information that is stored within the terminal. In response to a cache hit, the terminal transmits the address information corresponding to the query to the requesting local host. The query from the local host may also be forwarded by the terminal across a communications network, such as a satellite network, to a server that stores the requested address information. Upon receiving the requested address information, the terminal refreshes the cache.

According to one aspect of the invention, a method of performing an address look-up is disclosed. The method includes receiving a query from a local host requesting address information. The method also includes determining whether the address information is stored in memory, and selectively transmitting the address information to the local host based upon the determining step. The method also includes selectively forwarding the query over a communications network to a server to retrieve the address information. Under this approach, the user response time is significantly reduced.

According to another aspect of the invention, a terminal apparatus for transmitting packets over a communications network is disclosed. The terminal apparatus includes a communication interface that is configured to receive a query from a local host requesting address information. The terminal apparatus also includes a memory that is configured to store address information. Further, the terminal apparatus includes a processor that is coupled to the memory and the communication interface. The processor is configured to determine whether the address information associated with the query is stored in the memory, and to selectively transmit the address information to the local host in response to the determination. The processor further is configured to forward the query over the communications network to a server to retrieve the address information. This arrangement advantageously provides an improvement in application response time.

According to another aspect of the invention, a system for performing an address look-up is disclosed. A terminal is configured to receive a query from a local host requesting address information. The terminal includes a memory that is configured to store address information, and a processor that is coupled to the memory and configured to determine whether the address information associated with the query is stored in the memory. The processor is also configured to selectively transmit the address information to the local host in response to the determination. The system also includes a server that communicates with the terminal over a communications network. The server is configured to receive the query from the terminal and to transmit the address information corresponding to the query to the terminal. The above arrangement advantageously provides enhanced network performance.

In another aspect of the invention, a terminal apparatus that is capable of performing an address look-up is disclosed. The terminal apparatus includes means for receiving a query from a local host requesting address information, means for determining whether the address information is stored in memory, means for selectively transmitting the address information to the local host based upon the determination, and means for selectively forwarding the query over a communications network to a server to retrieve the address information. The above arrangement advantageously provides improved user response times.

In yet another aspect of the invention, a computer-readable medium carrying one or more sequences of one or more instructions for performing an address look-up is disclosed. The one or more sequences of one or more instructions include instructions which, when executed by one or more processors, cause the one or more processors to perform the step of receiving a query from a local host requesting address information. Other steps include determining whether the address information is stored in memory, selectively transmitting the address information to the local host based upon the determining step. Yet another step includes selectively forwarding the query over a communications network to a server to retrieve the address information. This approach advantageously provides enhanced system performance.

In yet another aspect of the invention, a method of performing an address look-up over a satellite network is disclosed. The method includes receiving a query from a local host requesting address information, and determining whether the address information is stored in a cache. The method also includes transmitting the address information to the local host in response to determining that the address information is stored in the cache; and selectively forwarding the query over the satellite network to a server to retrieve the address information. Under this approach, the impact of network latency is minimized.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of a Domain Name Service (DNS) address resolution process that may be employed in one embodiment of the present invention;

FIG. 2 is a diagram of the interaction among name servers in a simplified domain;

FIG. 3 is a diagram of a satellite communications system capable of employing an address caching mechanism, according to an embodiment of the present invention;

FIGS. 4A and 4B are, respectively, a diagram of a terminal with an address caching mechanism, and a message flow diagram of an address caching process, in accordance with an embodiment of the present invention;

FIG. 5 is a diagram of a topology of name servers that utilize an address caching mechanism, according to an embodiment of the present invention;

FIG. 6 is message flow diagram of an address caching process of the system of FIG. 5; and

FIG. 7 is a diagram of a computer system that can perform address caching, in accordance with an embodiment of the present invention.

### DESCRIPTION OF THE PREFERRED EMBODIMENTS

In the following description, for the purposes of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the invention.

Although the present invention is described with respect to the Domain Name System (DNS) and the global Internet, it is recognized by one of ordinary skill in the art that the present invention has applicability to address resolution in a packet switching system, in general.

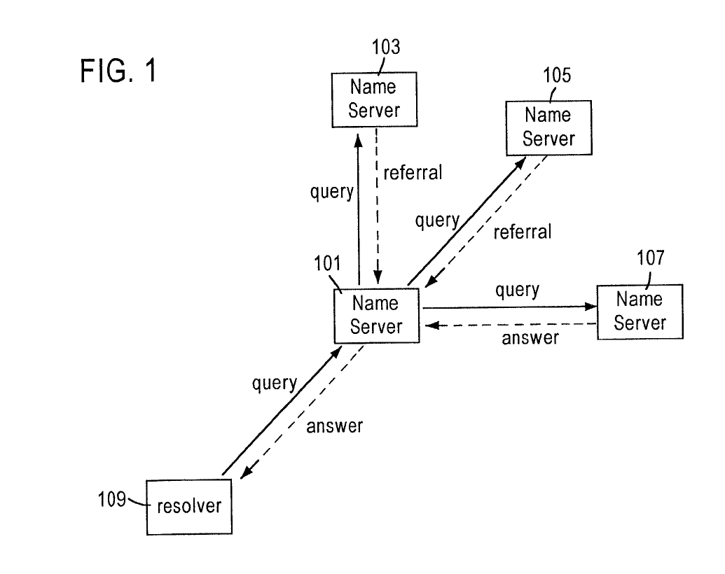

FIG. 1 shows a diagram of a Domain Name System (DNS) address resolution process that may be employed in one embodiment of the present invention. Every host in a network needs a mechanism to convert host names (i.e., symbolic addresses) to host addresses (i.e., numeric addresses) and vice-versa. As mentioned previously, the Internet DNS provide this capability by creating a distributed database that is used primarily for the translation between host names and IP addresses. This distributed database allows local control of the segments of the database, while making the overall database available across the entire network through a client-server scheme. Programs, known as “name servers” constitute the server half of the DNS client-server mechanism. Computing systems (e.g., personal computer, servers, work stations, etc.) that are loaded with name servers are also referred to as name servers; as used herein, a name server denotes the computer as well as the name server process that resides within the computer. Name servers 101, 103, 105, 107 contain information about some segment of the database and answers queries from clients, called “resolvers” 109. Resolvers 109 query name servers for data (i.e., address information) on behalf of user processes (or applications). Since no name server has complete information, in general it is necessary to obtain information from more than one name server to resolve a query.

One implementation of DNS is the Berkeley Internet Name Domain (BIND). In BIND, the resolver is just a set of library routines that are linked into programs (such as the File Transfer Protocol (ftp)). The resolver has the capability to generate a query, send the query, and wait for an answer to the query; further, if necessary, the resolver may resend the query if no response is received. In general, the burden of finding an answer to the query lies largely with the name server.

From the network perspective, there are two general classes of DNS traffic: (1) resolution traffic (message exchange relating to the query/answer), and (2) zone transfer traffic (message exchange relating to name server database synchronization). Resolution traffic passes between a resolver 109 and a name server (e.g., 101, 103, 105, and 107). Resolution traffic may also be passed between two name servers. Resolution traffic typically includes relatively small query/answer messages. In one implementation, resolution traffic is carried via UDP (User Datagram Protocol) (port 53); alternatively, TCP (Transmission Control Protocol) may be utilized, particularly when very large responses are involved.

Zone transfer traffic exists between name servers. For performance and reliability reasons, domains are mainly implemented using multiple name servers 101, 103, 105, and 107. These servers 101, 103, 105, and 107 keep their databases synchronized via the zone transfer mechanism. Zone transfer traffic may be carried via TCP (port 53) and include small query/answer messages for database update polling. When an update is detected, the updated database is downloaded to the requesting name server.

In the exemplary address resolution process of FIG. 1, a single resolver query can result in several DNS queries across several name servers 101, 103, 105, and 107. The address resolution process is initiated when a resolver 109 transmits a recursive query to a local name server. Two types of DNS queries are specified: recursive and iterative. Recursive queries places the burden of address resolution on a single name server. In recursion, the resolver 109 sends a recursive query to a name server 101 for information about a particular domain name. The name server 101 that is queried is then obligated to respond with the requested data—or with an error stating that data of the requested type does not exist or that the domain name specified does not exist. A name server that receives a recursive query in which it cannot answer, in turn, queries the “closest known” name servers; that is, authoritative name servers for the zone closest to the domain being queried. Normally the queried name server 101 does not send recursive queries to other name servers 103, 105, and 107. Instead, the name server 101 tracks down the answer using iterative queries.

An iterative query does not require nearly as much processing on the part of the receiving name server. In the iterative resolution, a name server that receives the query simply gives the best answer it already knows back to the querying name server, without performing any queries. The name server that is queried consults its local database and/or cache for the requested data. If the queried name server does not find the data, the queried name server makes its best attempt to provide the querying name server with data that helps the querying name server in continuing the resolution process by issuing “referrals”. A referral provides information about another name server that may have the requested address information, effectively redirecting the querying name server to another name server.

As seen in FIG. 1, the name server 109 sends an iterative query to name servers 103, 105, and 107 before finally finding the answer from the name server 107. On occasion, a name server that processes a recursive query may not have information regarding the “closest” name server; this scenario may arise from a recent reboot of the name server host, a totally expired cache, or a request for a top-level domain that has never before been accessed. In this case, the name server needs to obtain the data from a root name server. Per the protocol, all DNS servers have information on the location of the root name servers, so that the search for the next closest name server is guaranteed to stop at the root name server. The name servers for the root zone resolve top-level domains (i.e., com, .gov, org, .edu, and etc.). Root name servers are fixed, and are well known resources on the Internet.

The name servers 101, 103, 105, and 107 cache the answers that they receive from other servers. Each query response may include a time-to-live (TTL) value that informs the querying name server of the length of time to maintain that particular answer in its cache. This caching allows recursive queries to be resolved much more quickly since all the name servers along the line will have “better” referrals or the actual answer to a query.

Continuing with the example of FIG. 1, if the local name server 101 has an answer for the query in its cache, the name server 101 immediately replies to the resolver with the answer, and resolution is complete. However, if the local name server 101 does not have the answer in its cache, the name server 101 transmits iterative queries to other servers 103, 105, and 107 to find the answer. Typically, the name server 101 has knowledge of the “closest” name server that can answer a particular query, for example, in its cache. As a result, there is no need to query an Internet root name server. In this example, it is assumed that the name server 101 has no idea about the “closest” name server to look for an answer, and hence the name server 101 must communicate with a root name server, which for the purposes of explanation is name server 103. The answer from the root name server 103 usually is a referral. Next, the root name server 103 replies to the query from the name server 101 with a referral to the name server 105.

Accordingly, the name server 101 then issues another iterative query to the name server 105 per the referral from the root name server 103. If the name server 105 has the answer in its cache, the name server 105 would provide the answer to the name server 101. However, in this example, the name server 105 does not have the answer, and thus, responds with a referral to the name server 107. Continuing with the address resolution process, the name server 101 issues another iterative query to the name server 107. In this example, the name server 107 has the requested host name (or address) in its local database; this server 107 is said to be “authoritative” because the answer does not originate from its cache. The name server 107 then replies to the name server 101 with the answer to the query. In turn, the name server 101 sends the answer to the resolver 109. At this point, the address resolution process is complete and the resolver 109 possesses the necessary address information (e.g., IP address) to forward data to the machine with associated with the IP address.

It is noted that in actual implementation, the message exchanges among the resolver 109 and the name servers 101, 103, 105, and 107 may be more sophisticated. The sequential-queries and single-host-referrals in the example of FIG. 1 are discussed for the purposes of explanation. For example, the referrals that the name servers provide may list multiple hosts. Additionally, the name server that is processing a recursive query may issue multiple simultaneous queries.

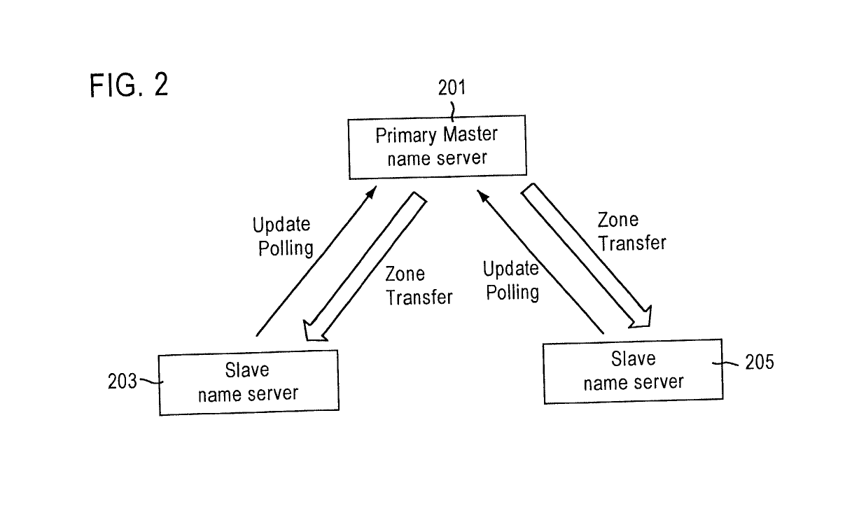

FIG. 2 shows a diagram of the interaction among name servers in a simplified domain. To better appreciate the present invention, it is instructive to describe the various ways that the DNS might be deployed across the network with a relatively high latency. These various ways are embodied in the concept of a zone transfer mechanism. While it is theoretically feasible for a single name server to handle all DNS transactions for a single domain (i.e., zone), for redundancy purposes, a minimum of two name servers for a particular domain are utilized. FIG. 2 illustrates a simple three-name server domain configuration. As shown, two types of name servers exist: a primary master name server 201 and a slave name server 203, 205. The significant difference between the primary master name server 201 and the slave name server 203, 205 concerns the location of the data; that is, where the server obtains its data. The primary master name server 201 reads its data from files, while the slave name server 203, 205 loads its data over a network from another name server.

The primary master name server 201 and the slave name servers 203, 205 can authoritatively answer queries for their segment of the DNS database. The slave name servers 203, 205 periodically poll the master name server 201, looking for updates on the database of the master name server 201. Typically, a single primary master name server 201 is employed per zone. However, any number of primary name servers may be used. When the slave name server 203, 205 detects a change in the database of its master name server 201, the slave name server 203, 205 requests a new copy of the entire database for that zone—this process is referred to as a “zone transfer.”

The organization of the name servers 201, 203, and 205 of FIG. 2 may be implemented in a variety of ways that may increase complexity to the zone transfer traffic. For example, a network design may implement multiple primary masters, wherein certain slave name servers obtain their updates from other slave servers instead of from the primary name server. Further, name servers that do not perform zone transfers (i.e., caching name servers) might be utilized. Also, subnet delegation (sub-domaining), which essentially fragments different parts of a zone's database across multiple primary master name servers, might be implemented. It should be noted that zone transfers and status polling may be occurring between several different name server pairs.

The above updating processes may be implemented using BIND 4.x or BIND 8.x. From the network point of view, the behavior of BIND 4.x and BIND 8.x are nearly identical. BIND 8.x has the additional capability that allows master name servers to NOTIFY slave name servers that a database update has occurred (as opposed to simply waiting for the polling mechanism to detect the change). BIND 8.2 also supports an optional incremental zone transfer function. Use of the incremental zone transfer function may significantly reduce the amount of data transferred between name servers during a zone transfer.

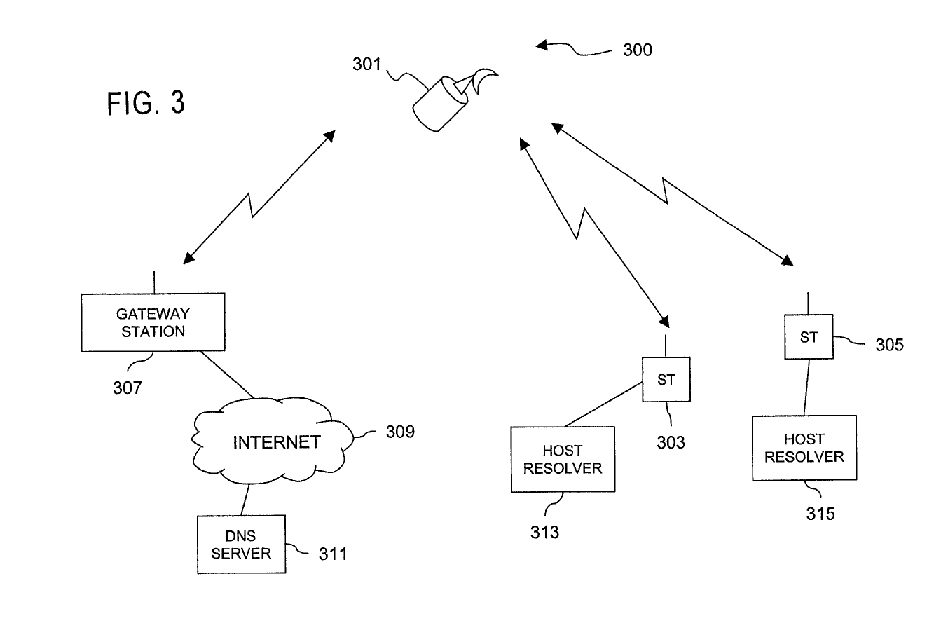

FIG. 3 shows a diagram of a satellite communications system capable of employing an address caching mechanism, according to an embodiment of the present invention. A communications system 300 includes a satellite 301 that supports communication among satellite terminals (STs) 303, 305. System 300 employs a gateway station 307 to manage and control communication services and operations. For example, the gateway station 307 provisions and identifies the channels that are to be used for the various packet delivery services, which are supported by the system 300. The gateway station 307 has connectivity to the Internet 309. A DNS server 311 is attached to the Internet 309 and may be a root name server.

In an exemplary embodiment, the STs 303, 305 are Very Small Aperture (VSAT) terminals, to which host resolvers 313 and 315 are respectively attached. Under this architecture, users can communicate from one VSAT ST to another directly with one satellite hop. Additionally, the host resolvers 313, 315 may obtain address information from the DNS server 111 over the satellite 301.

Satellite 301 contains a fast packet switch (FPS) (not shown) to process data packets that are exchanged across system 300. Exemplary switches include an ATM (Asynchronous Transfer Mode) switch, and a Gigabit Ethernet switch; it is recognized by one of ordinary skill in the art that any type of switch can be utilized. The FPS transfers the packets that the payload of the satellite 301 receives on the uplinks to the proper downlinks. The payloads of satellite 301 may include other components, such as uplink antenna, down-converters, switch matrix, demodulator banks, and phased-array downlink antenna; these other components are well known, and thus, are not described in detail.

The satellite 301 performs the necessary bandwidth control functions, in conjunction with the gateway station 307. In system 300, STs 303, 305 originate traffic from a particular coverage area and may transmit connectionless traffic as well as connection-oriented traffic. The generated traffic from these STs 303, 305 are transferred through switch and terminate at destination STs (not shown) within the same and/or different coverage area. That is, the destination STs can be within the same coverage area as the originating STs. To effectively transmit traffic to the desired destination ST through the switch of the satellite 301, STs 303, 305 transmit bandwidth requests to the satellite 301 prior to transmitting any data traffic.

A connection that is established between a source ST and a destination ST is controlled by the satellite 301 and the gateway station 307. The gateway station 307, which is based on the ground, provides management functions for the system 300. For example, an ST needs to obtain authorization from the gateway station 307 before making a request to the satellite 301. The gateway station 307 keeps track of the total uplink (and downlink) bandwidth available for connections and will block a connection request if there is insufficient satellite capacity available to satisfy the request.

As observed in FIG. 3, the host resolvers 313 and 315 must traverse over the satellite network to retrieve address information from the DNS server 311. Consequently, the application resident on the particular host that invoked the address resolution process would experience a greater delay because of the relatively high network latency of the satellite network. In recognition of this potential performance shortcoming, the present invention provides an address caching mechanism to minimize the effect of the network delay on the address resolution process.

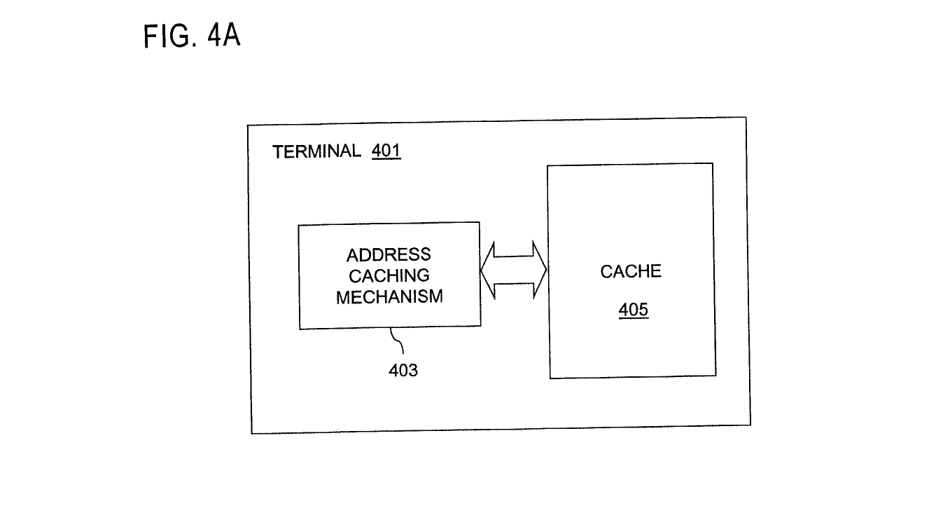

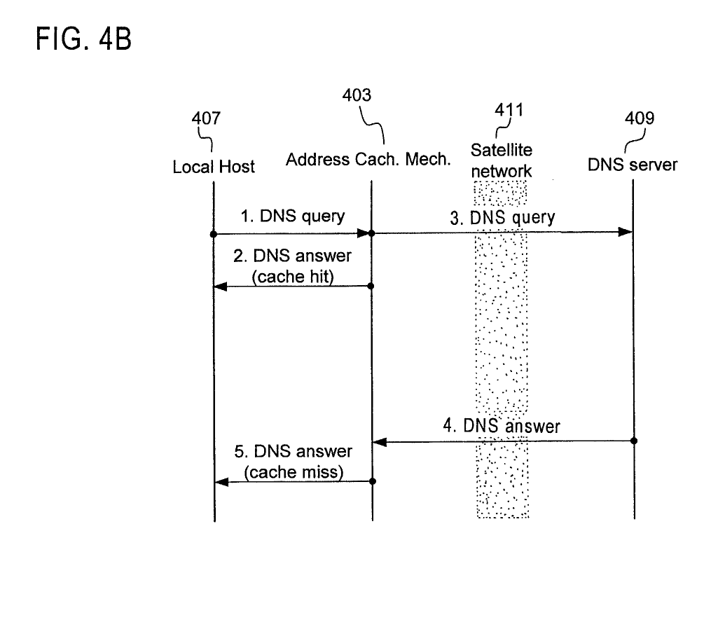

FIG. 4A shows a diagram of a terminal with an address caching mechanism, according to an embodiment of the present invention. Terminal 401, which may be a satellite terminal (ST) (e.g., STs 313, 315 of FIG. 3) includes an address caching mechanism 403 and a cache 405. The cache 405 stores symbolic address and numeric addresses to provide mapping from a symbolic address to a numeric address and vice-versa. The address caching mechanism 403 is introduced in the terminal 401 to reduce delays that are experienced by host applications in performing an address resolution process; such as the DNS look-up. This address caching mechanism 403 can be viewed as a combined cache and snooper, whose operation is described with respect to FIG. 4B.

FIG. 4B shows a message flow diagram of an address caching process, in accordance with an embodiment of the present invention. An end host 407 sends a DNS query in an IP datagram to a DNS server 409 via an ST 401 serving that host 407. In an exemplary embodiment, the ST 401 recognizes the IP datagram as a DNS query based on a UDP port number of 53, and directs the query to the address caching mechanism 403 within the ST 401. The address caching mechanism 403 snoops the query from the end host 407 and checks for a cache entry within the cache 405 to answer the query. If such an entry exists, the address caching mechanism 403 sends the local end host 407 a DNS response for the query.

According to one embodiment of the present invention, even though the address caching mechanism 403 has the requested entry within the cache 405, the query may nevertheless be forwarded by the terminal 401 over the satellite network 411 to the DNS server 409 specified in the query. Next, the DNS server 409 answers the query. When this answer arrives at the ST 401, it is directed to the address caching mechanism 403, which stores the answer in the cache 405. However, if no cache entry is found within the cache 405 (i.e., a cache miss), the address caching mechanism 403 forwards the answer received from the DNS server 409 to the local end host 407 that sent the query. The above approach significantly reduces the address look-up delay by providing a response immediately if the address information is stored locally within the cache 405 of the terminal 401.

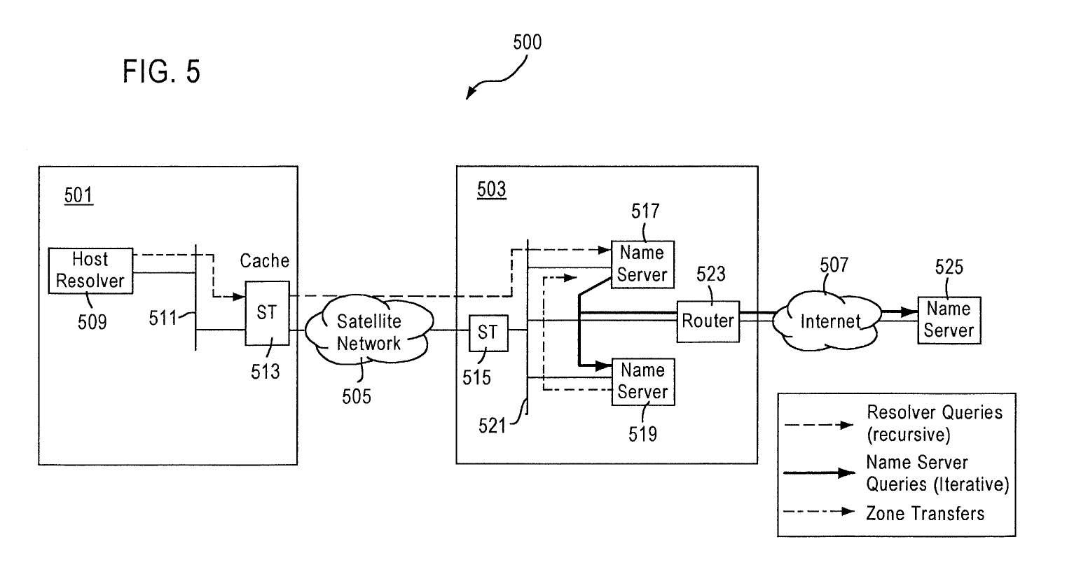

FIG. 5 shows a diagram of a topology of name servers that utilize the address caching mechanism, according to an embodiment of the present invention. In this example, a communications system 500 provides connectivity between a network 501 and another network 503 via a relatively high network latency network, such as a satellite network 505. In actual implementation, the network 501 may be considered the “service-consumer” side of the network 500, while the “service-provider” side rests within network 503.

The consumer side network 501 includes a host resolver 509 that is connected to a local area network (LAN) 511, which encompasses a ST 513. The service provider network 503 also utilizes a ST 515 which communicates to name servers 517, 519 via a LAN 521. A router 523 is attached to LAN 521 to forward data from the ST 515 to the Internet 507. A name server 525 is attached to the Internet 507.

The DNS traffic over the satellite network 505 is a function of how the various name servers 517, 519, 525 are distributed across the entire network 500 (networks 501, 503, and the Internet 507). In an exemplary embodiment, the name server 517 is a slave name server for the domain to which the host resolver 509 is a part; the name server 525 may be a root name server. The name server 519 serves as a primary master name server.

The configuration of system 500 utilizes an address caching mechanism within ST 513. In this arrangement, the end-user performance of DNS-intensive applications is enhanced because any cache “hits” resulting from a query from host resolver 509 triggers an immediate answer from the ST 513. The normal response from the DNS is used to refresh the cache of the ST 513.

The host resolver 509 is configured to use name server 517 for name and address look-ups, and behaves as a stub resolver (i.e., it only submits recursive queries). The name server 519 may be a BIND 4.x or 8.x server, which is configured as a primary master name server for the domain. STs 513 and 515 may function as IP routers, in which each interface has been assigned an IP address. Both STs 513, 515, in an exemplary embodiment, can transport UDP and TCP datagrams in either direction. According to one embodiment of the present invention, the resolver 509 and the name servers 517, 519, and 525 on the network 500 may have functional capabilities as defined in the following IETF (Internet Engineering Task Force) RFCs (Request for Comments): RFC 1034—Domain Names—Concepts and Facilities, RFC 1035—Domain Names—Implementation and Specification; which are incorporated herein by reference in their entireties. In addition, the name servers 517, 519, and 525 perform DNS updates in compliance with RFC 1101—DNS Encoding of Network Names and Other Types, RFC 1995—Incremental Zone Transfer in DNS, RFC 1996—A mechanism for Prompt Notification of Zone Changes (DNS NOTIFY), RFC 2535—Domain Name System Security Extensions, RFC 2181—Clarifications to the DNS Specification, RFC 2136—Dynamic Update in the Domain Name System (DNS UPDATE), RFC 2137—Secure Domain Name Systems Dynamic Update, and RFC 2308—Negative Caching of DNS Queries (DNS NCACHE); all of which are incorporated herein by reference in their entireties.

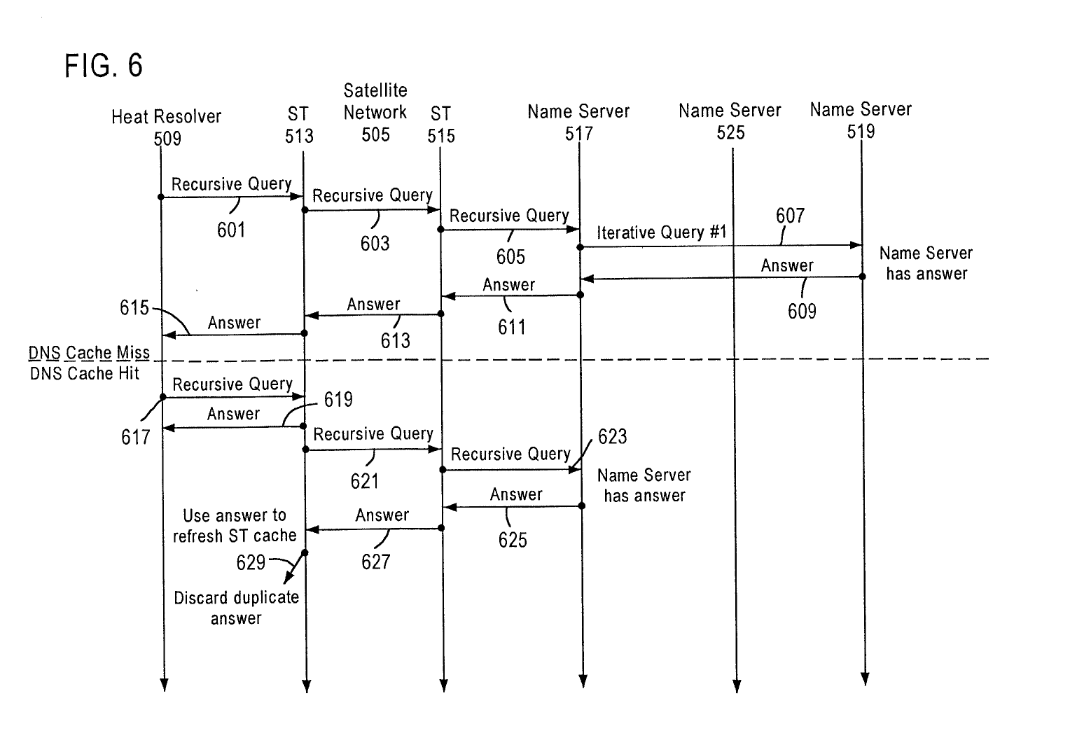

FIG. 6 shows a message flow diagram of an address caching process of the system of FIG. 5. The upper portion of the flow diagram illustrates the scenario involving a cache miss; the lower portion shows the case in which the query yields a cache hit. In step 601, a user application requires, for example, the IP address of a particular host. The application triggers a recursive query to a name server that is configured in the resolver 509, which in this example is name server 517. Since there are no name servers that are configured on the consumer side of the network 500, the query is processed by ST 513 within the network 501. By way of example, it is assumed that ST 513 does not have the answer in its cache, so the query is forwarded to the ST 515 on the service provider network 503 (per step 603). Next, the ST 515 forwards, as in step 605, the query to the name server 517. In this example, the name server 517 does not have the answer to the query in its database (or cache); as a result, the name server 517 sends, per step 607, an iterative query to the name server “nearest” to the answer, which in this case is name server 519. Because the name server 519 has the answer stored within either its cache or database, the name server 519 returns the answer to the requesting name server 517, as in step 609. Thereafter, the name server 513 returns the answer to the host resolver 509 via the satellite network 505 through ST 515 (per steps 611 and 613). In step 615, the host resolver 509 receives the answer and forwards it to the calling application.

The above scenario describes a cache miss in which the latency of the satellite network remains a factor; however, when a cache hit occurs, the quick answer to the query advantageously avoids the delay of the satellite network 505 from the perspective of the application. In step 617, a user application requires the IP address of a particular host, thereby causing the application to launch a recursive query to the name server 517, whose information is configured in the resolver 509. Unlike the scenario of steps 601-615, the ST 513 possesses the answer in its cache; consequently the ST 513 may immediately answer the query (per step 619). Upon receipt of the answer, the resolver receives the answer and forwards it to the calling application.

According to one embodiment of the present invention, the original query may be allowed to continue on to the name server 517 over the satellite network 505, as in step 621, to ST 515 on the service provider network 503 so that the cache of the ST 513 may be updated. Alternatively, the ST 513 may periodically launch queries on its own initiative to maintain the latest address information in its cache. In step 623, the ST 515 forwards the query to the name server 623, which has the answer stored within its database (or cache). Thus, in step 625, the answer is transmitted to the ST 515, which relays the answer over the satellite network 505 to the ST 513 (per step 627). The ST 513 in turn updates its cache, discarding the answer (since it is a duplicate from the resolver's perspective).

As evident from the above description of the address caching process, when the host resolver 509 issues a DNS query, there is essentially no delay when a cache hit occurs. As the look-up cache of the ST 513 grows, the performance degradation of DNS becomes negligible.

According to another embodiment of the present invention, the cache of the ST 513 may be pre-loaded with address information so that the transient performance impact of waiting for the cache to build up is eliminated. This address information may be derived from historical data, as users tend to utilize applications that target the same groups of destination hosts. In an exemplary embodiment, the ST 513 may be pre-loaded via a multicast delivery mechanism; such as the Multicast Transport Protocol as described in IETF RFC 1301, which is incorporated herein by reference in its entirety. This embodiment is particularly advantageous in an environment in which multiple remote terminals residing at different geographical sites are utilized, such as an enterprise network with remote nodes.

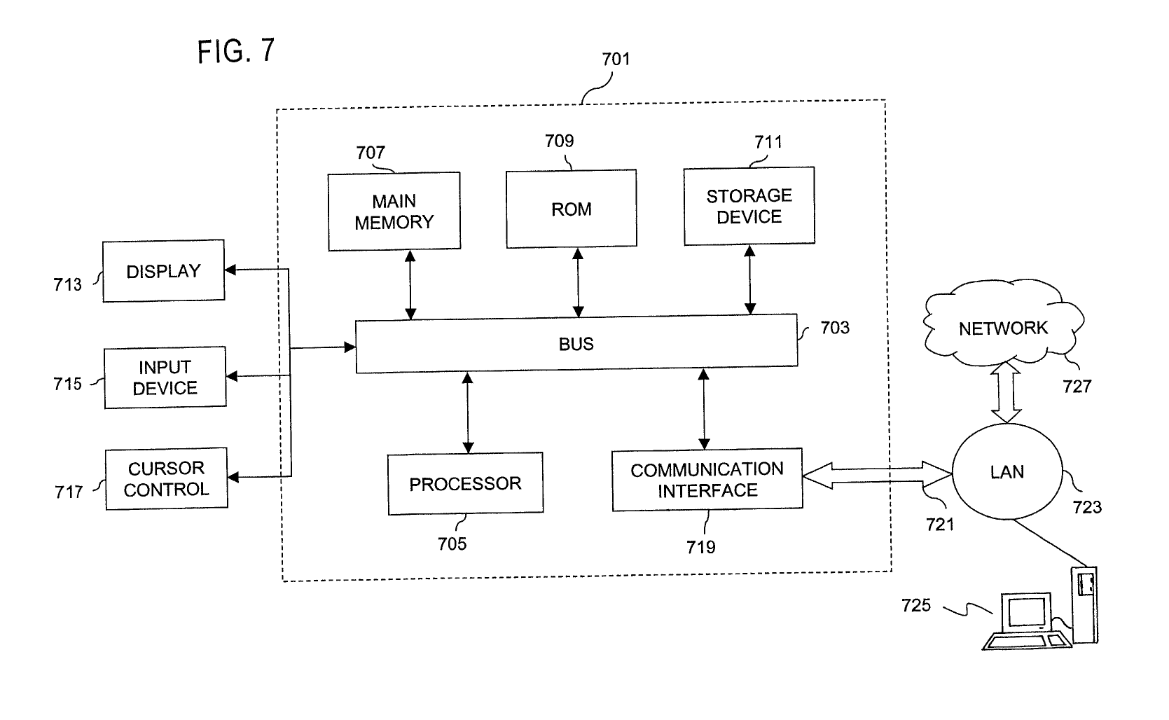

FIG. 7 illustrates a computer system 701 upon which an embodiment according to the present invention may be implemented. Computer system 701 includes a bus 703 or other communication mechanism for communicating information, and a processor 705 coupled with bus 703 for processing the information. Computer system 701 also includes a main memory 707, such as a random access memory (RAM) or other dynamic storage device, coupled to bus 703 for storing information and instructions to be executed by processor 705. In addition, main memory 707 may be used for storing temporary variables or other intermediate information during execution of instructions to be executed by processor 705. Computer system 701 further includes a read only memory (ROM) 709 or other static storage device coupled to bus 703 for storing static information and instructions for processor 705. A storage device 711, such as a magnetic disk, flash memory, or optical disk, is provided and coupled to bus 703 for storing information and instructions.

Computer system 701 may be coupled via bus 703 to a display 713, such as a cathode ray tube (CRT), for displaying information to a computer user. An input device 715, including alphanumeric and other keys, is coupled to bus 703 for communicating information and command selections to processor 705. Another type of user input device is cursor control 717, such as a mouse, a trackball, or cursor direction keys for communicating direction information and command selections to processor 705 and for controlling cursor movement on display 713.

According to one embodiment, the address caching mechanism of FIG. 4A may be implemented by computer system 701 in response to processor 705 executing one or more sequences of one or more instructions contained in main memory 707. Such instructions may be read into main memory 707 from another computer-readable medium, such as storage device 711. Execution of the sequences of instructions contained in main memory 707 causes processor 705 to perform the process steps described herein. One or more processors in a multi-processing arrangement may also be employed to execute the sequences of instructions contained in main memory 707. In alternative embodiments, hard-wired circuitry may be used in place of or in combination with software instructions. Thus, embodiments are not limited to any specific combination of hardware circuitry and software.

Further, the present invention may reside on a computer-readable medium. The term “computer-readable medium” as used herein refers to any medium that participates in providing instructions to processor 705 for execution. Such a medium may take many forms, including but not limited to, non-volatile media, volatile media, and transmission media. Non-volatile media includes, for example, optical or magnetic disks, such as storage device 711. Volatile media includes dynamic memory, such as main memory 707. Transmission media includes coaxial cables, copper wire and fiber optics, including the wires that comprise bus 703. Transmission media can also take the form of acoustic or light waves, such as those generated during radio wave and infrared data communication.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 705 for execution. For example, the instructions may initially be carried on a magnetic disk of a remote computer. The remote computer can load the instructions relating to the address caching mechanism remotely into its dynamic memory and send the instructions over a telephone line using a modem. A modem local to computer system 701 can receive the data on the telephone line and use an infrared transmitter to convert the data to an infrared signal. An infrared detector coupled to bus 703 can receive the data carried in the infrared signal and place the data on bus 703. Bus 703 carries the data to main memory 707, from which processor 705 retrieves and executes the instructions. The instructions received by main memory 707 may optionally be stored on storage device 711 either before or after execution by processor 705.

Computer system 701 also includes a communication interface 719 coupled to bus 703. Communication interface 719 provides a two-way data communication coupling to a network link 721 that is connected to a local network 723. For example, communication interface 719 may be a network interface card to attach to any packet switched local area network (LAN); e.g., a Universal Serial Bus (USB). As another example, communication interface 719 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 719 sends and receives electrical, electromagnetic or optical signals that carry digital data streams representing various types of information.

Network link 721 typically provides data communication through one or more networks to other data devices. For example, network link 721 may provide a connection through local network 723 to a host computer 725 or to data equipment operated by a service provider, which provides data communication services through a communication network 727 (e.g., the Internet). LAN 723 and network 727 both use electrical, electromagnetic or optical signals that carry digital data streams. The signals through the various networks and the signals on network link 721 and through communication interface 719, which carry the digital data to and from computer system 701, are exemplary forms of carrier waves transporting the information. Computer system 701 can transmit notifications and receive data, including program code, through the network(s), network link 721 and communication interface 719.

The techniques described herein provide several advantages over prior approaches to performing the address resolution process. A terminal employs an address caching mechanism to answer queries from a local host requesting address information. A cache hit yields an immediate response to the local host. In the case of a cache miss, the query is forwarded to an appropriate name server that returns the requested address information; at which time, the terminal may store this information in its cache. Accordingly, future requests for this particular address information may be rapidly supplied. This arrangement advantageously reduces response time, isolating the end-user application from the network latency associated with retrieval of the address information.

Obviously, numerous modifications and variations of the present invention are possible in light of the above teachings. It is therefore to be understood that within the scope of the appended claims, the invention may be practiced otherwise than as specifically described herein.

What is claimed is:

1. A method of performing an address look-up, the method comprising:
receiving a query from a local host requesting address information;
determining whether the address information is stored in memory;
selectively transmitting the address information to the local host based upon the determining step; and
selectively forwarding the query over a communications network to a server to retrieve the address information.

2. The method according to claim 1, further comprising:
updating the address information in memory with the retrieved address information from the server.

3. The method according to claim 1, wherein the query in the receiving step specifies a domain name, and the address information corresponding to the domain name is an Internet Protocol (IP) address.

4. The method according to claim 1, wherein the communications network includes a satellite that is configured to forward the query to the server.

5. The method according to claim 1, further comprising:
receiving a multicast message to pre-load the memory with the address information.

6. A terminal apparatus for transmitting packets over a communications network, comprising:
a communication interface configured to receive a query from a local host requesting address information;
a memory configured to store address information; and
a processor coupled to the memory and the communication interface, the processor being configured to determine whether the address information associated with the query is stored in the memory, and to selectively transmit the address information to the local host in response to the determination, the processor being configured to forward the query over the communications network to a server to retrieve the address information.

7. The terminal apparatus according to claim 6, wherein the processor is further configured to update the address information in the memory with the retrieved address information from the server.

8. The terminal apparatus according to claim 6, wherein the query specifies a domain name, and the address information corresponding to the domain name is an Internet Protocol (IP) address.

9. The terminal apparatus according to claim 6, wherein the communications network includes a satellite that is configured to forward the query to the server.

10. The terminal apparatus according to claim 6, wherein the communication interface is configured to receive a multicast message to pre-load the memory with the address information.

11. A system for performing an address look-up, comprising:
a terminal configured to receive a query from a local host requesting address information, the terminal comprising,
a memory configured to store address information, and
a processor coupled to the memory and configured to determine whether the address information associated with the query is stored in the memory, and to selectively transmit the address information to the local host in response to the determination; and
a server communicating with the terminal over a communications network, the server being configured to receive the query from the terminal and to transmit the address information corresponding to the query to the terminal.

12. The system according to claim 11, wherein the processor is further configured to update the address information in the memory with the address information from the server.

13. The system according to claim 11, wherein the query specifies a domain name, and the address information corresponding to the domain name is an Internet Protocol (IP) address.

14. The system according to claim 11, wherein the communications network includes a satellite that is configured to forward the query from the terminal to the server.

15. The system according to claim 11, wherein the terminal is configured to receive a multicast message to pre-load the memory with the address information.

16. A terminal apparatus capable of performing an address look-up, the terminal apparatus comprising:
means for receiving a query from a local host requesting address information;
means for determining whether the address information is stored in memory;
means for selectively transmitting the address information to the local host based upon the determination; and
means for selectively forwarding the query over a communications network to a server to retrieve the address information.

17. The terminal apparatus according to claim 16, further comprising:
means for updating the address information in memory with the retrieved address information from the server.

18. The terminal apparatus according to claim 16, wherein the query specifies a domain name, and the address information corresponding to the domain name is an Internet Protocol (IP) address.

19. The terminal apparatus according to claim 16, wherein the communications network includes a satellite that is configured to forward the query to the server.

20. The terminal apparatus according to claim 16, further comprising:
means for receiving a multicast message to pre-load the memory with the address information.

21. A computer-readable medium carrying one or more sequences of one or more instructions for performing an address look-up, the one or more sequences of one or more instructions including instructions which, when executed by one or more processors, cause the one or more processors to perform the steps of:
receiving a query from a local host requesting address information;
determining whether the address information is stored in memory;
selectively transmitting the address information to the local host based upon the determining step; and
selectively forwarding the query over a communications network to a server to retrieve the address information.

22. The computer-readable medium according to claim 21, wherein the one or more processors further perform the step of:
updating the address information in memory with the retrieved address information from the server.

23. The computer-readable medium according to claim 21, wherein the query in the receiving step specifies a domain name, and the address information corresponding to the domain name is an Internet Protocol (IP) address.

24. The computer-readable medium according to claim 21, wherein the communications network includes a satellite that is configured to forward the query to the server.

25. The computer-readable medium according to claim 21, wherein the one or more processors further perform the step of:
receiving a multicast message to pre-load the memory with the address information.

26. A method of performing an address look-up over a satellite network, the method comprising:
receiving a query from a local host requesting address information;
determining whether the address information is stored in a cache;
transmitting the address information to the local host in response to determining that the address information is stored in the cache; and
selectively forwarding the query over the satellite network to a server to retrieve the address information.

27. The method according to claim 26, further comprising:
refreshing the address information in the cache with the retrieved address information from the server.

28. The method according to claim 26, wherein the query in the receiving step specifies a domain name, and the address information corresponding to the domain name is an Internet Protocol (IP) address.

29. The method according to claim 26, further comprising:
receiving a multicast message containing a plurality of address information to pre-load the cache.

30. A satellite terminal for providing address information, comprising:
a cache configured to store address information; and
a processor coupled to the memory and configured to determine whether a query from a host requesting a particular address information produces a hit in the cache, wherein a cache hit causes transmission of the address information to the host, the processor being configured to forward the query over a satellite network to a server to retrieve the particular address information, the cache being updated with the retrieved particular address information.

31. The terminal according to claim 30, wherein the query specifies a domain name, and the address information corresponding to the domain name is an Internet Protocol (IP) address.

32. The terminal apparatus according to claim 30, wherein the cache is pre-loaded with address information via a multicast message.
